(19) United States
(12) Patent Application Publication
(10) Pub. No.: US 2016/0049816 A1
(43) Pub. Date: Feb. 18, 2016

(54) PORTABLE MEMORY POWER BANK

(71) Applicant: SAMYA TECHNOLOGY CO., LTD., Taoyuan County (TW)

(72) Inventor: FU-I YANG, TAOYUAN COUNTY (TW)

(21) Appl. No.: 14/458,378

(22) Filed: Aug. 13, 2014

(51) Int. Cl. H02J 7/00

(52) U.S. Cl. CPC H02J 7/0044

(57) ABSTRACT

A portable memory power bank comprises a charging loop, a battery, a discharging loop, a MCU, a USB charging port and a USB discharging port inside a body of a power bank, and a built-in portable memory including a memory unit, a controller and a voltage source. The controller is coupled to the memory unit to have access to the data therein and also coupled to the USB charging port and USB discharging port separately. The voltage source is separately coupled to the discharging loop and the controller in order to supply electric power to the controller. The present invention therefore has functions of power storage, power supply, data storage, and data transmission for devices such as cell phones and tablet PC. Moreover, the connected device is being charged while transmitting the data.

### BACKGROUND OF THE INVENTION

1. Field of the Invention

The present invention relates to a portable memory power bank, particularly to one that has functions of both power bank and portable memory.

2. Description of the Related Art

With advanced technology in the electronics industry and telecommunication industry, portable electronic products such as digital cameras, MP3, PDA, smart phones and tablet PC are getting more and more common; among all the accessories of which, battery is the most vital. Consequently, portable power banks are developed to meet the needs for electric power in any occasion, supplying power for the battery as well as the product.

On the other hand, considering the characteristics of the products as being light and portable, the space for data storage is therefore limited, leading the result that another portable hard drive has to be carried together for storing data. Hence, a user has to carry a power bank and a portable hard drive together when he is carrying a cell phone or a tablet PC with him, which would cause some inconveniences. In other words, there is still room for improvements.

### SUMMARY OF THE INVENTION

A primary object of the present invention is to provide a portable memory power bank that can connect a device like a cell phone or tablet PC to the portable memory inside the power bank for direct data transmission instead of turning on a computer to do so.

Another object of the present invention is to provide a portable memory power bank that can charge up the connected device while transmitting the data so that it has a dual function as a power bank and a portable memory device.

Yet another object of the present invention is to provide a portable memory power bank that can charge up the connected device and transmit the data in both directions in the meanwhile.

To achieve the objects mentioned above, the present invention comprises a body, a charging/discharging device disposed inside said body and having a charging loop in order to store the outside power in a battery, a discharging loop coupled to the battery in order to output the power therefrom, a MCU coupled to the charging loop, discharging loop and the battery, in order to hold control of the charging and discharging of the battery, a USB charging port arranged at a pre-determined side of the body for providing DC voltages for the charging loop, and a USB discharging port arranged at a pre-determined side of the body and coupled to the discharging loop;

wherein a portable memory is built inside the body, comprising a memory unit, a controller coupled to the memory unit to have access to the data therein and also coupled to the USB charging port and USB discharging port separately, and a voltage source coupled to the discharging loop and the controller separately in order to supply electric power to the controller, featuring the body as having built-in structures of both power bank and portable memory.

With structures disclosed above, the memory unit further has a USB port for memory cards to be inserted in, or the USB port can be built on the circuit board inside the body. The body has a switch thereon which is coupled to the controller of the portable memory, so as to control the data transmission in the memory unit.

As structures disclosed above, the present invention has functions of power storage, power supply, data storage, and data transmission for devices such as cell phones and tablet PC. Moreover, it is charging the connected device while transmitting the data.

### BRIEF DESCRIPTION OF THE DRAWINGS

FIG. 1 is a perspective view of the present invention in a preferred embodiment;

FIG. 2 is a block diagram of the circuit of the present invention in a preferred embodiment; and

FIG. 3 is a practical application view of the present invention.

### DETAILED DESCRIPTION OF THE PREFERRED EMBODIMENT

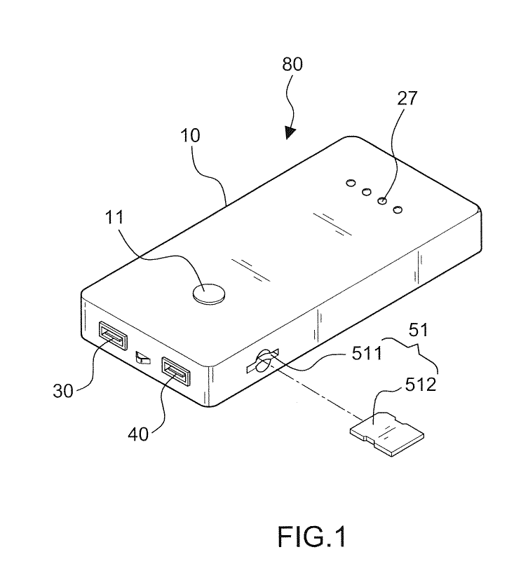

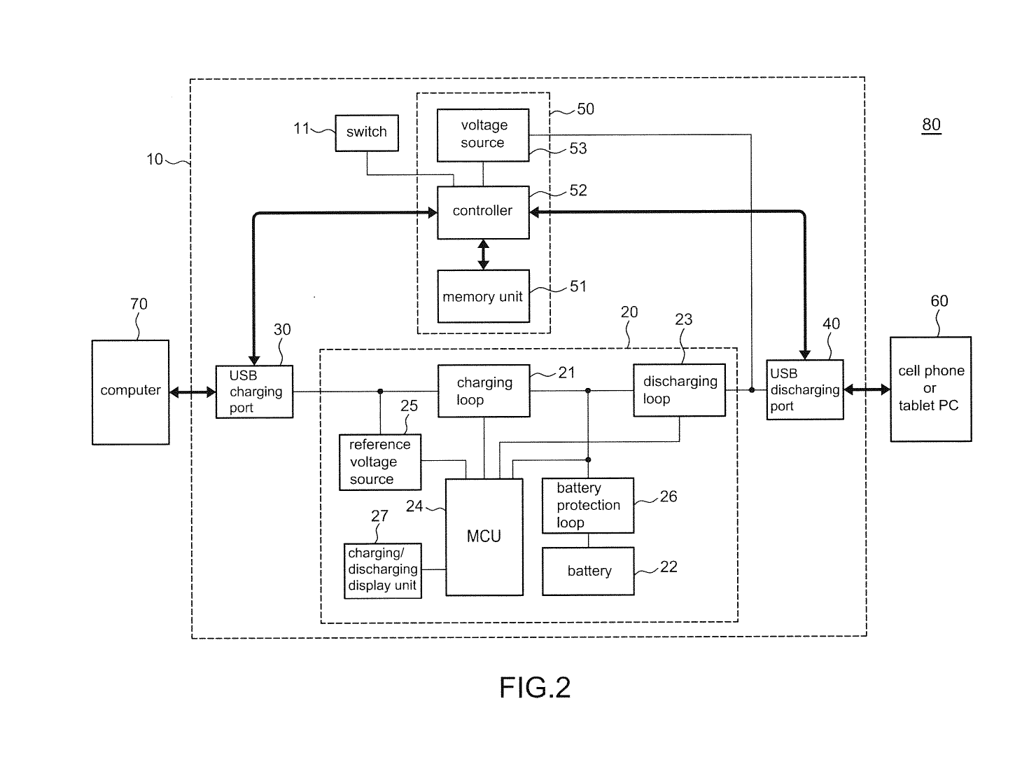

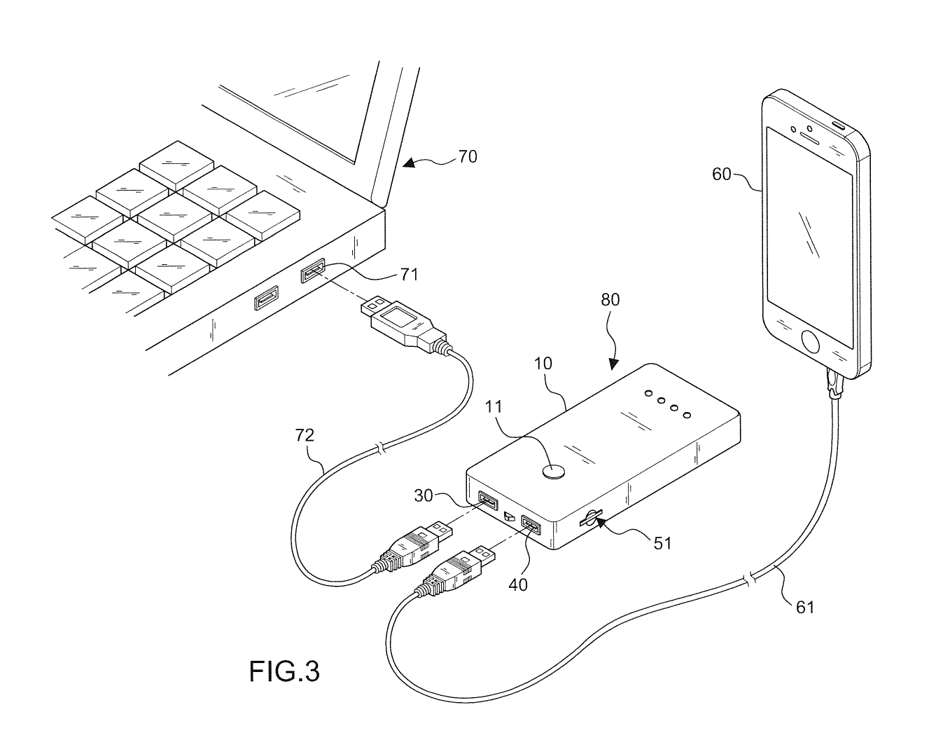

Referring to FIGS. 1-3, in an applicable embodiment, the present invention comprises a body 10, a charging/discharging device 20 disposed inside said body 10 and having a charging loop 21 in order to store the outside power in a battery 22, a discharging loop 23 coupled to the battery 22 in order to output the power therefrom, a MCU 24 coupled to the charging loop 21, discharging loop 23 and the battery 22, in order to hold control of the charging and discharging of the battery 22, a USB charging port 30 arranged at a pre-determined side of the body 10 for providing DC voltages for the charging loop 21, and a USB discharging port 40 arranged at a pre-determined side of the body 10 and coupled to the discharging loop 40. In this embodiment, the charging/discharging device 20 further includes a reference voltage source 25 coupled in-between the USB charging port 30 and the MCU 24, a battery protection loop 26 coupled to the battery 22, the MCU 24 and the charging loop 21, and a charging/discharging display unit 27 coupled to the MCU 24 so as to form the structure of a power bank;

wherein a portable memory 50 is built inside the body 10, comprising a memory unit 51. a controller 52 coupled to the memory unit to have access to the data therein and also coupled to the USB charging port 30 and USB discharging port 40 separately, and a voltage source 53 coupled to the discharging loop 23 and the controller 52 separately in order to supply electric power to the controller 52, featuring the body 10 as having built-in structures of both power bank and data storage. In the aforesaid structures, the specifications of USB charging port 30 and the USB discharging port 40 conform to the communication protocols of Universal Serial Bus, Mini Universal Serial Bus, and Micro Universal Serial Bus.

In the embodiment, the memory unit 51 further has a USB port 511 for memory cards to be inserted in but is not limited to such application. For instance, the memory unit 51 can be built on the circuit board inside the body 10 in another applicable embodiment (not shown in the FIGS.). In addition, the memory unit 51 has a built-in App that can be a Micro SD card, Secure Digital card (SD), Near Field Communication card (NFC), Compact Flash Card (CF), Smart Media card (SMC), Multi Media card (MMC), or Memory Stick card (MS), but is not limited to such applications. It is connected to a portable device like a cell phone 60 or tablet PC by having a transmission cable 61 connected to the USB discharging port 40 thereof. The memory unit 51 can be used as an extra memory space and accessed by the connected device.

Furthermore, the body 10 has a switch 11 thereon, coupled to the controller 52 of the portable memory 50, so as to control the data transmission in the memory unit 51; in the embodiment, the memory unit 51 can be a Flash Memory but is not limited to such application.

As the structures stated above, the present invention has a bidirectional data transmission function via the built-in App. Additionally, when connecting to a computer 70, either desktop or laptop, the present invention is being charged via a transmission cable 72 connected to the USB port 71 thereof, and is able to transmit the data in the meanwhile. On the other hand, when the present invention is connected to a cell phone 60 or a tablet PC with its switch 11 turned on, it is charging the device and available for data transmission as well. When there is no need for data transmission, the present invention is simply functioning as a power bank.

In conclusion, the present invention has functions of power storage, power supply, data storage, and data transmission for devices such as cell phones and tablet PC. Moreover, it is charging the connected device while transmitting the data, providing more conveniences for its users.

Although a particular embodiment of the invention has been described in details for purposes of illustration, various modifications and enhancements may be made without departing from the spirit and scope of the invention. Accordingly, the invention is not to be limited except as by the appended claims.

What is claimed is:

1. A portable memory power bank, comprising:
a body;
a charging/discharging device disposed inside said body and having a charging loop in order to store the outside power in a battery;
a discharging loop coupled to the battery in order to output the power therefrom;
a MCU coupled to the charging loop, discharging loop, and the battery, in order to hold control of the charging and discharging of the battery;
a USB charging port arranged at a pre-determined side of the body for providing DC voltages for the charging loop; and
a USB discharging port arranged at a pre-determined side of the body and coupled to the discharging loop;
wherein a portable memory is built inside the body, comprising:
a memory unit;
a controller coupled to the memory unit to have access to the data therein and also coupled to the USB charging port and USB discharging port separately;
a voltage source coupled to the discharging loop and the controller separately in order to supply electric power to the controller;
whereby the body has built-in structures of both power bank and data storage.

2. The portable memory power bank as claimed in claim 1, wherein the memory unit can be a Flash Memory.

3. The portable memory power bank as claimed in claim 1, wherein the memory unit further has a USB port for memory cards to be inserted in.

4. The portable memory power bank as claimed in claim 1, wherein the memory unit is built inside the body.

5. The portable memory power bank as claimed in claim 1, wherein the body has a switch thereon, which is coupled to the controller of the portable memory, so as to control the data transmission in the memory unit.

6. The portable memory power bank as claimed in claim 1, wherein the charging/discharging device further includes a reference voltage source coupled in-between the USB charging port and the MCU, a battery protection loop coupled to the battery, the MCU and the charging loop, and a charging/discharging display unit coupled to the MCU.
